(19) United States
(12) Patent Application Publication
(10) Pub. No.: US 2025/0347575 A1
(43) Pub. Date: Nov. 13, 2025

(54) SYSTEMS AND METHODS FOR SMALL AREA LEAK DETECTION

(71) Applicant: GE-Hitachi Nuclear Energy Americas LLC, Wilmington, NC (US)

(72) Inventors: Brian S. Hunt, Spring Grove, PA (US); Mark A. Sapia, Canton, CT (US); Zachary Sweeney, Wilmington, NC (US)

(21) Appl. No.: 19/206,026

(22) Filed: May 12, 2025

Related U.S. Application Data
(60) Provisional application No. 63/645,827, filed on May 10, 2024.

(51) Int. Cl. G01M 3/16; G01M 3/18; G21C 17/00

(52) U.S. Cl. CPC G01M 3/165; G01M 3/186; G21C 17/002

(57) ABSTRACT

Leakage detection systems and methods of monitoring leakage using probes of fiber optic and/or Time Domain Reflectometry (TDR) cables that provide at least one of an electric and electromagnetic signal upon coming in contact with a liquid from the pool. An interrogator may be multiplexed with several of the cables and generate interrogation signals whose reflection determines an exact position along the cable of leakage contact. The cables may be run under a floor and/or wall of a spent fuel pool or other liquid volume in a nuclear power plant. Leakage even of deionized water near room temperature may be detectable. The cables may be a single serpentine cable or several straight cables wrapping around the volume. The cables may be small, such as 10 millimeters or less in diameter. Cables may be run behind liners at any pitch or interval, potentially between supporting structures and the liner.

### RELATED APPLICATIONS

This application claims priority under 35 U.S.C. § 119 to co-pending U.S. Provisional Application 63/645,827, filed May 10, 2024 and incorporated by reference herein in its entirety.

### BACKGROUND

Leak detection of deionized water requires specialized sensors, because deionized water typically presents little chemical indication of its presence. Mechanical or other rudimentary sensors such as floats are thus more commonly used for larger volumes, where leakage might instead be detected through change in water level. In nuclear power plants and related installations, radioactive water leaking can be detected with radiation measuring devices, or heat or thermal sensors can be used to detect leaks of steam or very hot water.

In ambient temperature water pools using deionized water, such as spent fuel pools, makeup pools, suppression pools, etc. related art leak detection systems includes leak chases that can be up to 7-8″ or more thick and drain to pipes which have sight glasses in them to indicate the presence of water and/or estimate the approximate size of the leak rate. Related art leak chase systems are described in NRC, “SONGS Unit 1 Spent Fuel Pool Liner Plate Evaluation” of Mar. 1, 1995 and LEE et al., “Development of Air-Tight Leak Chase System for In-Service Inspection of Pool Liner,” 2016 Autumn Meeting of the KN, incorporated herein by reference in their entireties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include systems and methods of monitoring leakage using probes of fiber optic and/or Time Domain Reflectometry (TDR) cables that provide at least one of an electric and electromagnetic signal upon coming in contact with a liquid from the pool. An interrogator may be multiplexed with several of the cables and generate interrogation signals whose reflection determines an exact position along the cable of leakage contact. The cables may be run under a floor and/or wall of a spent fuel pool or other liquid volume in a nuclear power plant. Leakage even of deionized water near room temperature may be detectable. The cables may be a single serpentine cable or several straight cables wrapping around the volume. The cables may be small, such as 10 millimeters or less in diameter. Cables may be run behind liners at any pitch or interval, potentially between supporting structures and the liner while requiring little or no space or drainage.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of an example embodiment system using probes at several vertical heights in walls of a leakage-monitored volume.

FIG. 2 is an illustration of the example embodiment system of FIG. 1 using probes at several horizontal spacings in walls of a leakage-monitored volume.

FIG. 3 is an illustration of the example embodiment system of FIG. 1 using probes at positions in a floor of a leakage-monitored volume.

FIG. 4 is an illustration of the example embodiment system of FIG. 1 using a serpentine probe in a wall of a leakage-monitored volume.

FIG. 5 is an illustration of the example embodiment system of FIG. 1 using probes with several interrogators for a leakage-monitored volume.

FIG. 6A is a cross-sectional illustration of an example embodiment probe in a floor with a sheath.

FIG. 6B is a cross-sectional illustration of an example embodiment probe in a wall with a flow diverter.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.

The inventors have recognized existing moisture and leak detection systems rely on large collectors to detect liquid temperature or evaporation and/or require ionized or contaminated water to detect. For example, many leak detectors in nuclear systems rely on the resulting conductivity or radioactivity of the ion-bearing or radioactive solvent to detect a leak. In the case of reactor building ambient temperature pools with potentially minimal ion content, related art leak detection systems use leak chases which can be up to 7-8″ or more thick which drain to pipes which have sight glasses in them to indicate the presence of water or in the case of small leaks estimate the approximate size of the leak rate. This leakchase system can increase the total volume requirement of the installed pool by up to 7% or more. Detectors using large mechanical structures like floats take up a lot of space and require in-pool positioning and connections to work. There is thus a newly-recognized need to leak detectors that can work in small spaces and with potentially very small amounts of non-ionized water. Example embodiments discussed herein solve these and other problems newly recognized by the inventors . . . pool by up to 7% or more. Given this is a very expensive structure, and the structures outside the pool must grow commensurately to accommodate it, reducing the required volume for leak detection can result in significant cost savings for nuclear power plant construction. Furthermore, maintenance is reduced significantly by the present invention, and operate is greatly simplified. Where today's technology is limited to zones of detection and limited by the number of leakchases and requires isolation of a zone of a leakchase in order to identify which zone is leaking—the present invention can detect with high confidence the location of a leak and also detect how large the leak is . . . . To overcome these newly-recognized problems as well as others, the inventors have developed example embodiments and methods described below to address these and other problems recognized by the inventors with unique solutions enabled by example embodiments.

The present invention is . . . . In contrast to the present invention, the few example embodiments and example methods discussed below illustrate just a subset of the variety of different configurations that can be used as and/or in connection with the present invention.

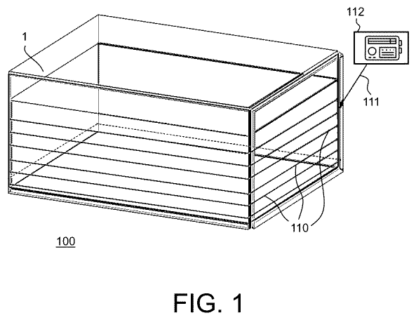

FIG. 1 is an illustration of an example embodiment leak detection system 100. As shown in FIG. 1, several deionized water detection probes are embedded within walls of a volume 1 to be monitored for leaking. For example, volume 1 may be a spent fuel pool in a nuclear power plant, or a makeup pool or any other pool in the same. Volume 1 may also be a pipe, channel, reactor vessel, or any other body from which leakage of a fluid is needed to be monitored and can support detection probes about its exterior that may leak.

As shown in FIG. 1, several probes 110 may be embedded about an exterior of volume 1 at particular vertical heights. Each probe 110 is capable of detecting and reporting contact with the leaked fluid, including deionized water, at specific positions along its length. In the example of FIG. 1, probes 110 may extend about a horizontal perimeter of volume 1, such as across particular liquid heights or internal seams of a spent fuel pool. Each probe 110 may be multiplexed or otherwise joined with a transmitter or splitter 111 that connects all probes 110 to interrogator 112. In this way, moisture or leakage detection by any probe 110 may be individually identified and a position along probe 110 for the leakage also identified. This may permit precise height and position determination of any leak from volume 1.

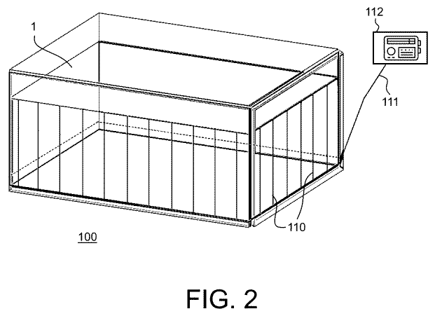

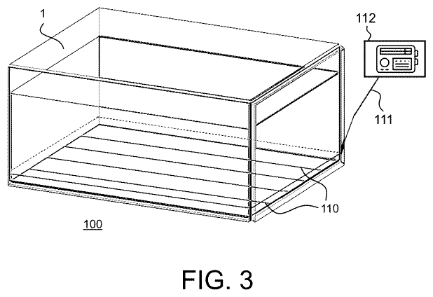

FIG. 2 illustrates additional probes 110 that can be used running in a vertical manner from a combined lead line to transmitter of splitter 111. In probes 110, a position of leakage along a distance of probes 110 may be associated with a particular vertical height in a wall of volume 1. FIG. 3 illustrates yet further probes 110 useable in example system 100 running within or adjacent to a bottom floor of volume 1. Probes 110 of FIG. 3 may detect leakage along their length to give an accurate position of a break or other leakage about floor of volume 100.

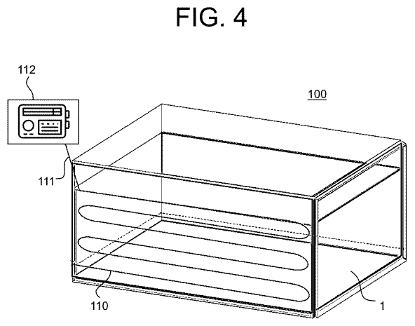

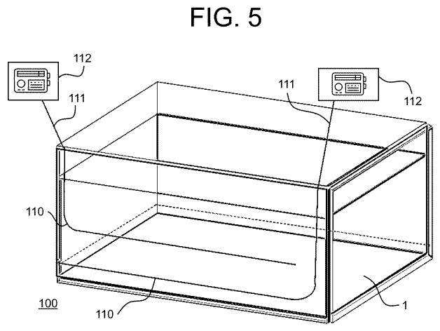

FIG. 4 illustrates probes 110 at different horizontal and vertical positions in a serpentine fashion. Based on detection of moisture at any location along probe 110, a specific height and horizontal position in a given surface about which probe 110 winds or extends can be identified as a leakage source. Although FIGS. 1-4 show multiple probes multiplexing or otherwise joining a transmitter to a single interrogator 112, FIG. 5 shows that multiple interrogators 112 may be joined to probes 110, on a 1-to-one basis or in other numbers.

System 100 may include any or all of the probes 110 of FIGS. 1-4, in any combination and potentially overlapping on a single surface. Probes 100 may be at any desired interval or density, including pitches or separation within a surface that aligns with seams, welds, or other failure points in liners of the same. Example embodiment probes 110 may be positioned on an exterior, or embedded within, a dry, or non-liquid contacting, space about volume 1, including within walls or liners or on the exterior of the same. By reporting contact with leakage from volume 1 at any point along their length, probes 110 together may permit identification of leakage with sufficient granularity to identify even small liner failures or early leaks, potentially at most likely or critical failure points.

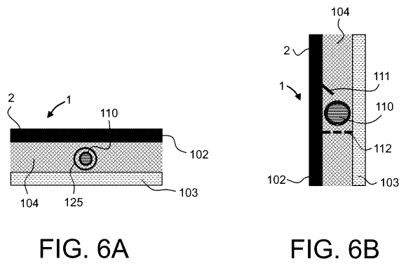

FIGS. 6A and 6B illustrate cross-sections of system 100 at probes 110, about a plane perpendicular to a length of probes 110. As shown in FIGS. 6A and 6B, probes 110 may be just behind liner 2, or separated from a fluid-containing space of volume 1 by liner 2. For example, liner 2 may be a stainless steel sheet, concrete, or welded stainless steel runs of a spent fuel pool wall. The space required for probe 110 may be very small, typically on the order of the cable's diameter, such as 2 mm or less in a horizontal or vertical direction in FIGS. 6A and 6B.

Probes 110 be in open air or within a material of liner 2, or potentially behind the same embedded in a transmissive medium, such as grout or sand, porous enough to allow the fluid to make contact with probe 110. Still further a sheath or surrounding membrane 125 that is porous to enable permeability or features holes or openings to allow transmission to probe 110 to detect fluid leakage. FIG. 6A is an example of how probe 110 may be placed horizontally under the volume. FIG. 6B is an example of probe in a vertical wall for leak detection. As shown in FIG. 6B, an open interstitial space 104 exists behind liner 2 with only support structures present between liner 2 and wall or floor 103. Shelves 12 can be installed in this space to better capture leaking water to ensure entrance into the space and/or contact with probe 110, whether placed in the vertical or horizontal orientation. A diverter or tray 111 may be welded onto liner 2 underneath a horizontal weld joint to direct fluid into or onto probe 110 before proceeding downward.

Space 104 behind liner 2 may be filled with sand or concrete or grout after probes 110 are secured in place to support structures 103, which may be steel or concrete, for example. Any fill in space 104 may be placed during or after the pool liner has been installed, so as to provide structural support for liner 2 as expansion may occur at a higher rate than the steel or concrete structure 103. Fills in space 104 may further prevent probes 110 from being crushed while also diffusing and increasing area of the leaking fluid, to ensure it contacts probe 110 for detection faster. Space 104 may also retain leaked fluids and allow drainage or air dry of the leaked fluids simply by blowing or otherwise flowing dry or absorbent air through space 104, with probes 110 being immediately capable of use after drying and detecting when drying is completed.

Probes 110 in example embodiment system 100 may be compact, simplified, and/or work with deionized water. Example embodiments may use Time Domain Reflectometry (TDR) using coaxial, twin lead, and/or fiber optic cable as probes 110. In the case of a coaxial or twin lead cable, electromagnetic signals are transmitted into the cable and received to indicate both the presence of and location of a leak of deionized, such as from interrogator 112. The signal's time-of-flight can be measured to indicate the location along the cable where the air to water interface occurs. This may indicate a position of the top of the fluid relative to a fixed probe wire. TDR can detect even a small leak of water and even if the water is deionized and of very low conductivity. Most fluids regardless of conductivity or contamination with generate a measurable signal change at a determinable position upon contact with a TDR cable.

Using a TDR cable in probe 110, one or a series of low-energy electromagnetic impulses generated by circuitry of interrogator 112 is propagated along a thin wave guide of probe 110, which may be one single long electromagnetic wave conductor or an array of long conductors, such as a metal rod, a steel cable, or a metal thin tube with a coaxially fixed metal rod in the middle. When these impulses propagate to the surface of the medium to be measured, an impedance mismatch due to the different dielectric constants of the two phases causes part of the impulse energy to be reflected back up the probe to the circuitry due to the mismatch of the dielectric and/or permeability properties. This reflection and the timing of its receipt versus signal generation determines the position of the fluid contact along probe 110. Deionized water is a paramagnetic material, which also contributes to the reflected signal in example embodiments using the same.

Example embodiment systems using TDR may measure a partially wetted medium surrounding the probe rather than just a water to air interface. Given the deionized water's lack of conductivity, this was unexpected to be effective. The length of the TDR cable can be long enough to cover a large footprint surrounding a spent fuel pool or tank. Thus, reducing any gaps in coverage that would otherwise be present with a method based on discrete sensors. An additional advantage can be realized with either RF transmission or fiber optic TDR where multiple cables or fibers can be interrogated with the same instrument by multiplexing or time separation of signals. Therefore, achieving full coverage for leak monitoring can be accomplished at low cost. TDR cables have an expected lifetime is 60-80+ years of operation. If example embodiment system 100 must be maintained and/or replaced during this timeframe, the detection cable may be replaced if needed.

Example embodiment systems 100 may use fiber optic cable in probes 110 in a similar configuration but utilizing the transmission of a light signal, also an electromagnetic wave, which is modified by the medium around it. Interrogator 112 connected to fiber optic cables may interpret a wide variety of signals from the same as physical phenomena sensed, corresponding to wetting and thus leakage. For example, scattering may be used by interrogator 112 to translate received signals into sensor data. Raman, Brillouin, and Rayleigh scattering, potentially using Stokes or anti-Stokes shifts, may be used to detect wetting at cable positions in probes 110. For example, interrogator 112 may translate radiated outputs from into temperatures sensed at positions through Rayleigh scattering. Rayleigh scattering may result from density and composition variations in the material of the cables. Light from Rayleigh scattering may be distributed randomly along the whole length of a cable. This light, backscattered to interrogator 112 from Rayleigh scattering from existing impurities or variations in the cable may be related to sensed phenomena. For example, an amount and type of light backscattered to interrogator 112 may correlate with wetting, strain, and/or temperature in the fiber core with resolutions up to 1με and 0.1° C. respectively. 1με is equal to 1 μm/m, or 10e-6 meters deformation per meter length.

Interrogator 112 may process the light with spatial resolution that allows for significant sensing distance. Spatial resolution of up to 20 microns can be achieved for a sensing distance up to 30 meters, with up to a sensing distance of 2 km possible before further resolution is not possible. Interrogator 112 may detect continuously-distributed strain along three different planes with different loading conditions in the fiber optic cables of probes 110. Similarly, several sensed phenomenon are detectable using Raman scattering, including, wetting, temperature, pressure, stress, seismic, etc, based on strain and temperature effects on the optical fiber. For example, interrogator 112 may translate radiated outputs into temperatures sensed along the fiber optic cables through Raman scattering. The Raman effect occurs when light interacts with vibrational modes of molecules in materials the cable. The light scattered back to interrogator 112 correlates to the molecular structure and temperature of the material.

For example, Raman scattering can be used to measure material temperature changes in optical fiber-based gamma thermometry. When gamma radiation interacts with the material of the cables, including its core and/or cladding, it produces a small amount of light due to Compton scattering. This light is then scattered through Raman scattering by interacting with molecular vibrations of the material. The frequency and intensity of the scattered light received by interrogator can be correlated with temperature change in the material when adjusted for the refractive index of the fiber material and the molecular vibrations of the material.

Raman scattering may provide highly-accurate leakage measurements because Raman scattering is sensitive to temperature changes and has a narrow spectral linewidth, allowing for precise measurements. Raman scattering can also provide information about health of the cables, allowing degradation to be detected and monitored. Particularly, light transmitted from Raman scattering typically has a spectrum with peaks linearly related to material symmetry and structural properties of fiber optic cable. The peaks in the spectrum occur at intervals that depend on the physical characteristics of the optical phonon vibration, thus producing a fingerprint unique to that material. The interval may be the frequency shift from the optical phonon vibration modes and is related to the rotational and vibrational components of each phonon excitation energy at the time it encounters light. The frequency shift may appear as a positive shift (Stokes scattering) when the phonons receive energy and a negative shift (anti-Stokes scattering) when the phonons emit energy. The relative intensity of the Stokes and anti-Stokes peaks depends on the temperature of the optical phonon system, which follows a Boltzmann distribution.

Similarly, several sensed phenomenon are detectable using Brillouin scattering, including, temperature and mechanical properties based on acoustical properties on the optical fiber. For example, interrogator 112 may translate radiated outputs of cables in probes 110 into temperatures sensed through Brillouin scattering. In Brillouin scattering, when gamma radiation interacts with materials of the cable, it produces a small amount of light due to Compton scattering. Some of this light interacts with the acoustic phonons of the array material and undergoes Brillouin scattering. Interrogator 112 may then receive the scattered light to determine the temperature change in the material. Brillouin scattering takes into account several factors, including frequency and intensity of the incident light, the refractive index of the fiber material, and the acoustic phonons of the material. Brillouin scattering can provide temperature and wetting property measurements simultaneously because the frequency shift of the scattered light is related to the temperature of the material, while the linewidth of the scattered light is related to the mechanical properties of the material. Brillouin scattering may also provide accurate measuring of temperature and mechanical properties in materials that are difficult to measure using traditional methods. Because of its unique use of acoustic phonons.

Example embodiments using TDR cables or fiber optic cables in probes 110 can significantly reduce space and/or costs for leak detection, which can result in significant cost savings for nuclear power plant construction that is especially sensitive to space required for pool fuel storage and coolant storage. Example embodiment systems 100 may require less maintenance and enjoy simpler operation by avoiding multiple drainage channels and directional filling pipes of related art leak chase systems. Example embodiment systems 100 may be operate with a single probe 100 or set of probes capable of discriminating between position and amount of leak contact without needing isolation of a zone of a leak chase to identify which zone is leaking. Example embodiment systems 100 may not require removal of leaked fluid or require dryout that could take a very long time and lead to corrosion challenges or other issues such as bacteria and organic growth, etc. but are useable with forced drying to dry leaked-into space within days or weeks rather than months or years.

Some example embodiments and methods thus being described, it will be appreciated by one skilled in the art that examples may be varied through routine experimentation and without further inventive activity. For example, although some placement of probes in spent fuel pool walls and floors are shown together in some example embodiments and methods, it is understood that use of probes at other locations and other storage and flow structures are useable with example embodiments and methods. Variations are not to be regarded as departure from the spirit and scope of the example embodiments, and all such modifications as would be obvious to one skilled in the art are intended to be included within the scope of the following claims.

1. A method of monitoring leakage about a pool, the method comprising:
installing a Time Domain Reflectometry (TDR) cable outside a liner of the pool, wherein the TDR cable is configured to provide at least one of an electric and electromagnetic signal upon coming in contact with a liquid from the pool.

2. The method of claim 1, further comprising:
installing a plurality of the TDR cables; and
attaching the TDR cables to at least one interrogator configured to receive the signals.

3. The method of claim 2, further comprising:
generating interrogation signals from the interrogator and propagating the interrogation signals down the TDR cable, wherein the signals received by the interrogator are reflected interrogation signals.

4. The method of claim 1, wherein the TDR cable is run under a floor of the pool.

5. The method of claim 1, wherein the TDR cable is run vertically behind a wall of the pool.

6. The method of claim 1, wherein the TDR cable is a single cable having S-turns so as to follow multiple directions.

7. The method of claim 1, wherein the pool is a pool of deionized water maintained below 80° C.

8. A method of monitoring leakage about a volume, the method comprising:
installing a cable of 10 mm or less diameter on an exterior of the volume, wherein the cable is configured to provide a signal upon coming in contact with a liquid from the volume.

9. The method of claim 8, wherein the cable is at least one of a Time Domain Reflectometry cable and a fiber optic cable, the method further comprising:
connecting the cable to an interrogator configured to determine a position on the cable of the contact with the liquid based on the signal.

10. The method of claim 9, wherein the interrogator transmits an interrogatory signal that is at least one of electric and electromagnetic, and wherein the signal provided by the cable is the interrogatory reflected at the contact.

11. The method of claim 8, wherein the cable is run under a floor of a spent fuel pool in a commercial nuclear power plant.

12. The method of claim 8, wherein the cable is run vertically behind a wall of a spent fuel pool in a commercial nuclear power plant.

13. The method of claim 8, wherein the cable is a single cable having S-turns so as to follow multiple directions.

14. The method of claim 8, wherein the pool is a pool of deionized water maintained below 80° C.

15. The method of claim 8, wherein the volume is a pool of deionized water used as a coolant in a commercial nuclear power plant.

16. A system for leak-free coolant maintenance in a pool, the system comprising:
a cable outside a liner of the pool, wherein the cable is configured to reflect at least one of an electric and electromagnetic signal from a point of contact with a liquid from the pool.

17. The system of claim 16, further comprising:
the pool, wherein the pool is a spent fuel pool in a commercial nuclear power plant.

18. The system of claim 16, further comprising:
the pool, wherein the liquid is deionized water used as a coolant in a commercial nuclear power plant.

19. The system of claim 16, wherein the cable is at least one of a Time Domain Reflectometry cable and a fiber optic cable, the system further comprising:
an interrogator connected to the cable and configured to determine a position on the cable of the contact with the liquid based on the signal.

20. The system of claim 16, further comprising:
the liner; and
a support structure supporting the liner, wherein the cable is in a separation space between the liner and the support structure.
